(19) United States
(12) Patent Application Publication
(10) Pub. No.: US 2016/0078667 A1
(43) Pub. Date: Mar. 17, 2016

(54) METHOD AND APPARATUS FOR PROCESSING RENDERING DATA

(71) Applicant: Samsung Electronics Co., Ltd., Suwon-si (KR)

(72) Inventors: Heejun SHIM, Seoul (KR); Soojung RYU, Hwaseong-si (KR); Hoyoung KIM, Seoul (KR); Sunmin KWON, Seoul (KR); Seonghoon JEONG, Yongin-si (KR)

(73) Assignee: Samsung Electronics Co., Ltd., Suwon-si (KR)

(21) Appl. No.: 14/692,472

(22) Filed: Apr. 21, 2015

(30) Foreign Application Priority Data
Sep. 17, 2014 (KR) 10-2014-0123705

(51) Int. Cl. G06T 15/04; G06T 11/00; G06T 15/00; G06T 17/20

(52) U.S. Cl. CPC G06T 15/04; G06T 17/20; G06T 11/001; G06T 15/005

(57) ABSTRACT

A method and apparatus of processing rendering data are disclosed. The method of processing rendering data includes comparing texture information of a first tile with texture information of a second tile that is rendered after the first tile, selecting at least one piece of texture data from pieces of texture data of the first tile according to a frequency of use of the at least one piece of texture data for rendering the second tile, and changing the selected at least one piece of texture data into another piece of texture data. When an image is rendered, the method and apparatus may more efficiently use resources.

### RELATED APPLICATION

This application claims the benefit under 35 USC 119(a) of Korean Patent Application No. 10-2014-0123705, filed on Sep. 17, 2014, in the Korean Intellectual Property Office, the entire disclosure of which is incorporated by reference for all purposes.

### BACKGROUND

1. Field

The following description relates to methods and apparatuses for processing rendering data.

2. Description of Related Art

Devices that render three-dimensional (3D) images and display the rendered 3D images on screens are being spotlighted. For example, the market for devices to which user interface (UI) applications are used in mobile devices and applications where simulation is applied has expanded.

As businesses using 3D images have expanded, the amount of rendering data that is to be processed by devices in order to more accurately perform 3D image rendering has increased. When the devices process the rendering data while applications are executed, a larger memory space and a longer time are required.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Provided are methods and apparatuses that use resources more efficiently by determining rendering data to be stored and changed during image rendering in consideration of the characteristics of the rendering data in order to reduce the amount of used memory space and time.

According to an aspect there is provided a method of processing rendering data, the method including comparing texture information of a first tile with texture information of a second tile that is rendered after the first tile, selecting at least one piece of texture data from pieces of texture data of the first tile according to a frequency of use of the at least one piece of texture data for rendering the second tile, and changing the selected at least one piece of texture data into another piece of texture data.

The selecting of the at least one piece of texture data may include determining a priority of texture data to be changed based on the texture data to be changed having a lesser frequency of use.

The comparing of the texture information may include comparing the texture information of the first tile with texture information of each of a plurality of the tiles rendered after the first tile.

The method may include obtaining information about a rendering order of tiles included in a rendering image, wherein the comparing of the texture information may include selecting at least one tile that is rendered after the first tile based on the rendering order.

The selecting of the at least one piece of texture data may include selecting the at least one piece of texture data based on a size of data, from pieces of texture data of the first tile having a frequency of use lower than a value.

The comparing of the texture information may include obtaining information about some tiles included in a rendering image and comparing the information, wherein in response to the at least one piece of texture data being selected and changed from among the some tiles, the method may include obtaining and comparing information about others tiles included in the rendering image.

The method may include comparing texture information between a plurality of tiles included in a rendering image and determining a rendering order of the plurality of tiles according to a similarity of the texture information between the plurality of tiles.

The comparing of the texture information may include comparing the texture information of the first tile that is selected with the texture information of the second tile that is rendered after the first tile, based on texture information of tiles adjacent to the first tile.

The plurality of pieces of texture data of the first tile may be stored in a memory.

The plurality of pieces of texture data of the first tile may be stored in a graphics processing pipeline of a graphics processor.

According to another aspect there is provided an apparatus for processing rendering data, the apparatus including a controller configured to compare texture information of a first tile with texture information of a second tile that is rendered after the first tile, a memory to stores pieces of texture data used to render the first tile, and a data changer configured to select at least one piece of texture data from pieces of texture data that are stored in the memory according to a frequency of use of the least one piece of texture data for rendering of the second tile, and to change the selected at least one piece of texture data into another piece of texture data.

The controller may be further configured to determine a priority of texture data to be changed based on the texture data to be changed having a lesser frequency of use.

The controller may be further configured to compare the texture information of the first tile with texture information of each of a plurality of the tiles rendered after the first tile.

The controller may be further configured to obtain information about a rendering order of tiles included in a rendering image, and to select at least one tile that is rendered after the first tile based on the rendering order.

The data changer may be further configured to select the at least one piece of texture data based on a size of data from pieces of texture data of the first tile having a frequency of use lower than a value.

The controller may be further configured to obtain and compare information about some of tiles that are included in a rendering image, wherein in response to the at least one piece of texture data being selected and changed from among the some tiles, the controller may obtain and compare information about others tiles included in the rendering image.

The apparatus may include a scheduler configured to compare texture information between a plurality included in a rendering image of tiles and to determine a rendering order of the plurality of tiles according to a similarity of the texture information between the plurality of tiles.

The controller may be further configured to compare the texture information of the first tile that is selected with the texture information of the second tile that is rendered after the first tile, based on texture information of tiles that are adjacent to the first tile.

According to another aspect there is provided a method of processing rendering data, the method including comparing texture information of a first tile with texture information of a second tile that is rendered after the first tile, selecting at least one piece of texture data from pieces of texture data of the first tile based on a size of the pieces of texture data of the first tile and the at least one piece of texture data having a frequency of use lower than a threshold when rendering the second tile, and changing the selected at least one piece of texture data into another piece of texture data.

Other features and aspects will be apparent from the following detailed description, the drawings, and the claims.

### BRIEF DESCRIPTION OF THE DRAWINGS

FIG. 1 is a diagram illustrating an example of an image rendering system for processing rendering data.

FIG. 2 is a diagram illustrating an example of a method of processing rendering data.

FIG. 3 is a diagram illustrating an example of a method of processing rendering data.

FIG. 4 is a diagram illustrating an example of a method of processing rendering data based on a type and a size of texture data, wherein the method is performed by an apparatus for processing rendering data (hereinafter, referred to as the rendering data processing apparatus).

FIG. 5 is a diagram illustrating an example of a method of scheduling a rendering order of tiles based on texture information of the tiles, where in the method is performed by the rendering processing apparatus.

FIG. 6 is a diagram illustrating an example of a method of processing rendering data when image rendering is performed in units of a preset number of tiles.

FIG. 7 is a diagram illustrating an example of the rendering data processing apparatus.

FIG. 8 is a diagram illustrating an example of a rendering data processing apparatus.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses, and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element is referred to as being “connected” to another element, it may be “directly connected” to the other element or “electrically connected” to the other element with intervening elements therebetween. It will be further understood that when a part “includes” or “comprises” an element, unless otherwise defined, the part may further include other elements, not excluding the other elements.

As used herein, the term “and/or” includes any and all combinations of one or more of the associated listed items. Expressions such as “at least one of,” when preceding a list of elements, modify the entire list of elements and do not modify the individual elements of the list.

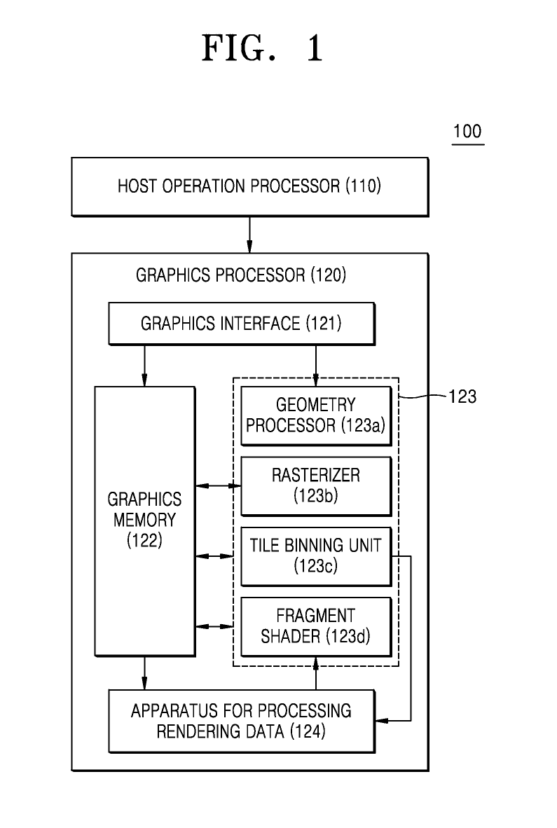

FIG. 1 is a diagram illustrating an example of an image rendering system 100 (hereinafter, referred to as the rendering system 100) for processing rendering data.

Only some elements of the rendering system 100 related to the present examples are shown in FIG. 1. Accordingly, it will be understood by one of ordinary skill in the art that the rendering system 100 may further include general-purpose elements other than those shown in FIG. 1.

Referring to FIG. 1, the rendering system 100 may include a host operation processor 110 and a graphics processor 120 that processes rendering data. As a non-exhaustive illustration only, the rendering system 100 may described herein may refer to mobile devices such as, for example, a cellular phone, a smart phone, a wearable smart device (such as, for example, a ring, a watch, a pair of glasses, glasses-type device, a bracelet, an ankle bracket, a belt, a necklace, an earring, a headband, a helmet, a device embedded in the cloths or the like), a personal computer (PC), a tablet personal computer (tablet), a phablet, a mobile internet device (MID), a personal digital assistant (PDA), an enterprise digital assistant (EDA), a digital camera, a digital video camera, a portable game console, an MP3 player, a portable/personal multimedia player (PMP), a handheld e-book, an ultra mobile personal computer (UMPC), a portable lab-top PC, a global positioning system (GPS) navigation, a personal navigation device or portable navigation device (PND), a handheld game console, an e-book, and devices such as a high definition television (HDTV), an optical disc player, a DVD player, a Blue-ray player, a setup box, robot cleaners, or any other device that performs many of the functions of a computer, typically having a touchscreen interface, Internet access, and an operating system capable of running applications.

The host operation processor 110 may perform an operation to execute a graphics application such as a user interface (UI) application or an application for simulation. The graphics application may be an application that requires image rendering. For example, a game application and a video application may be included in the graphics application. The host operation processor 110 may generate a high-level command to process rendering data while the graphics application is executed. The rendering data may include texture information of an image to be rendered or of objects that are included in the image.

The graphics processor 120 communicates with the host operation processor 110. The graphics processor 120 may render an image to execute an application in the host operation processor 110, based on the high-level command received from the host operation processor 110, and may provide the rendered image to the host operation processor 110.

Referring to FIG. 1, the graphics processor 120 may include a graphics interface 121, a graphics memory 122, a graphics processing pipeline 123, and an apparatus for processing rendering data 124 (hereinafter, referred to as the rendering data processing apparatus 124).

The graphics interface 121 may receive the high-level command from the host operation processor 110 and may transmit the received high-level command to the graphics memory 122 and the graphics processing pipeline 123.

The graphics memory 122 may store the high-level command received from the graphics interface 121 and may store rendering data to perform rendering in the graphics processing pipeline 123.

The graphics processing pipeline 123 may render and output an image. The graphics processing pipeline 123 may include a geometry processor 123a, a rasterizer 123b, a tile binning unit 123c, and a fragment shader 123d.

The geometry processor 123a may receive data according to an application-specific data structure and may generate vertices based on the received data. The geometry processor 123a may convert a three-dimensional (3D) position of each of the vertices in a virtual space into a depth value of a Z buffer and two-dimensional (2D) coordinates to be shown on a screen. The geometry processor 123a may generate a primitive (for example, a line, a point, or a triangle) that may be executed based on vertex data.

The rasterizer 123b may interpolate texture coordinates and screen coordinates that are defined from the vertices in the primitive that is received from the geometry processor 123a and may generate information of fragments in the primitive. The terms ‘fragments’ and ‘pixels’ may be interchangeably used herein.

The tile binning unit 123c divides a image to be rendered into tiles having a preset size. Sizes of the tiles may be set to be the same or different from one another. The tile binning unit 123c may obtain texture information of each of the tiles when dividing the rendering image. The texture information may include information about colors and textures of fragments that are included in each tile. The texture information obtained by the tile binning unit 123c may be stored in the graphics memory 122 or the rendering data processing apparatus 124.

The fragment shader 123d calculates texture mapping and light reflection for each fragment that is included in the rendering image in tile units and determines a color and a texture of each fragment. In order to determine the color and the texture of each fragment that is included in each tile in tile units, the fragment shader 123d may obtain texture data from the graphics memory 122 or the rendering data processing apparatus 124. The fragment shader 123d may determine the texture of each fragment based on the obtained texture rendering data. The fragment shader 123d may efficiently receive, from the rendering data processing apparatus 124 texture data of tiles that are rendered after a selected tile according to a rendering order.

The rendering data processing apparatus 124 provides texture data to perform texture rendering of a tile in consideration of a locality of texture data of each of the plurality of tiles. The locality of the texture data of each of the plurality of tiles is determined based on the texture information of the plurality of tiles obtained by the tile binning unit 123c.

The rendering data processing apparatus 124 may previously store texture data that is used to render the selected tile. The rendering data processing apparatus 124 may determine which texture data is to be changed from among the texture data that is previously stored, based on tile information of the tiles (hereinafter, referred to as the second tiles) that are rendered after the selected tile (hereinafter, referred to as the first tile).

The rendering data processing apparatus 124 may change texture data having a relatively low frequency of use from among the texture data that is previously stored into one piece of texture data, in consideration of a frequency of use of at least one piece of texture data that is used to render the second tiles. Since the texture data that is previously stored is changed in consideration of the frequency of use, the rendering data processing apparatus 124 may reduce the number of operations of obtaining texture data from the graphics memory 122, thereby more efficiently using resources.

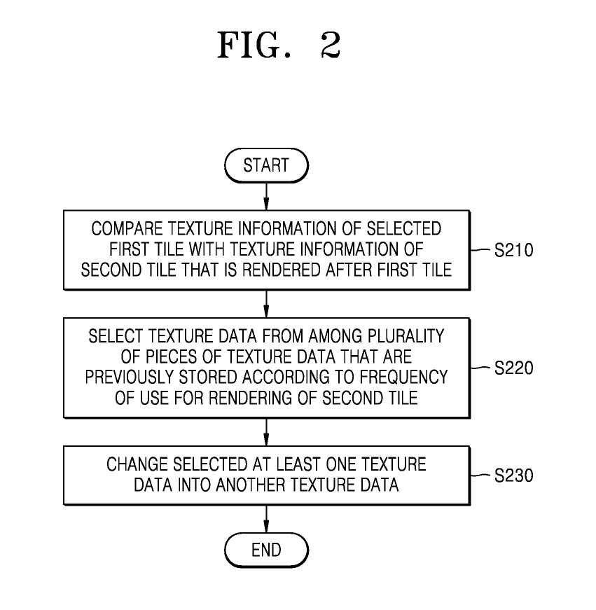

FIG. 2 is a diagram illustrating an example of a method of processing rendering data. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently. The above descriptions of FIG. 1, is also applicable to FIG. 2, and is incorporated herein by reference. Thus, the above description may not be repeated here. Although the rendering data may be any of data to render an image, the following will be explained on the assumption that the rendering data is texture data for convenience of explanation.

In operation S210, the rendering data processing apparatus 124 compares texture information of a selected first tile with texture information of a second tile that is rendered after the first tile, based on texture information of a plurality of tiles that are included in a rendering image. The rendering data processing apparatus 124 may obtain the texture information of the plurality of tiles that are included in the rendering image from the tile binning unit 123c. The rendering data processing apparatus 124 may also obtain the texture information of the plurality of tiles from the graphics memory 122.

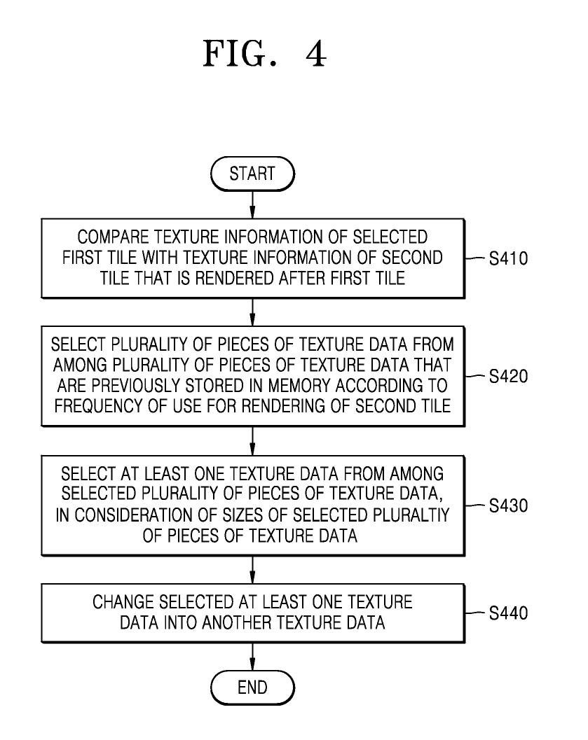

The rendering data processing apparatus 124 may compare a type of texture information that is used to render fragments that are included in the first tile with a type of texture information that is used to render fragments that are included in the second tile. The rendering data processing apparatus 124 may identify texture data that is used to render the second tile and texture data that is not used to render the second tile, from among texture data that is used to render the first tile according to a result of the comparison. The rendering data processing apparatus 124 may compare sizes of the texture data instead of types of the texture data between the first tile and the second tile, which will be explained below with reference to FIG. 4.

The rendering data processing apparatus 124 may compare the texture information of the first tile with texture information of each of the second tiles. The rendering data processing apparatus 124 may compare texture information of each of a preset number of second tiles with the texture information of the first tile, from among the plurality of second tiles that are included in the image that is not yet rendered. The number of second tiles to be compared may vary according to setting information. The rendering data processing apparatus 124 may select only one second tile, or a plurality of second tiles, for example, 2 or 4 second tiles.

The rendering data processing apparatus 124 may consider a rendering order of the plurality of tiles, to select the second tile. The rendering data processing apparatus 124 may obtain information about a rendering order in which the plurality of tiles are rendered from the tile binning unit 123c or the graphics memory 122. The rendering data processing apparatus 124 may select at least one second tile that is rendered after the selected first tile, based on the information about the rendering order. For example, the rendering data processing apparatus 124 may compare the texture information of the first tile with texture information of each of four second tiles beginning from a second tile that is rendered first after the selected first tile to a second tile that is rendered fourth after the selected first tile.

The rendering data processing apparatus 124 may select at least one second tile, from among tiles that are adjacent to the selected first tile in the rendering image. For example, when rendering is performed in units of some of the plurality of tiles that are included in the rendering image in the graphics processing pipeline 123, the rendering data processing apparatus 124 may obtain texture information about the tiles that are adjacent to the selected first tile. When rendering is performed in units of some tiles in the graphics processing pipeline 123, a unit of tiles, on which rendering is performed, may be determined according to a physical distance between the tiles. For example, from among 14 tiles that are included in the rendering image, rendering may be performed in units of 4 (2×2) tiles. Accordingly, in this case, the rendering data processing apparatus 124 may obtain texture information by selecting the second tile from among the tiles that are adjacent to the selected first tile. The rendering data processing apparatus 124 may compare the obtained texture information of the second tile with the texture information of the selected first tile.

In operation S220, the rendering data processing apparatus 124 selects at least one piece of texture data from among a plurality of pieces of texture data including texture data of the first tile that are previously stored in a memory according to a frequency of use for rendering of the second tile, based on a result of the comparison.

For example, when first texture data, second texture data, and third texture data are used to render the first tile and the first texture data and the third texture data are used to render the second tile, the rendering data processing apparatus 124 may select the second texture data that is not used to render the second tile.

The rendering data processing apparatus 124 may determine a priority of texture data to be changed, from among a plurality of pieces of texture data of the first tile that are previously stored according to a frequency of use for rendering of the second tile. Rendering data having a relatively low frequency of use for rendering of the second tile, from among the plurality of pieces of texture data that are previously stored, may have a higher priority.

The rendering data processing apparatus 124 may determine at least one piece of texture data to be changed according to setting information such as a unit of tiles to be rendered, from among the plurality of pieces of texture data that are previously stored and each have the determined priority. For example, assuming that rendering is performed in units of adjacent tiles in the rendering image, when rendering on tiles that are included in a first tile unit is completed, in order to perform rendering on tiles that are included in a second tile unit, all of pieces of texture data having priorities from a first priority to a middle priority may be changed. In contrast, while rendering is performed on the tiles that are included in the first tile unit, only the texture data having the first priority may be changed.

The rendering data processing apparatus 124 may select at least one piece of texture data to be changed based on a size of data, from among pieces of texture data of the first tile having a frequency of use that is lower than a preset value. A method of changing at least one piece of texture data in consideration of a size of texture data will be explained below with reference to FIG. 4.

In operation S230, the rendering data processing apparatus 124 changes the selected at least one piece of texture data into another piece of texture data. The rendering data processing apparatus 124 may change texture data having a low frequency of use in the second tile into texture data that is expected to be used during rendering after the first tile. For example, first texture data, second texture data, and third texture data may be used to render the first tile, the first texture data and the third texture data may be used to render a 2-1 tile, and the first texture data, the third texture data, and fourth texture data may be used to render a 2-2 tile. In this case, the rendering data processing apparatus 124 may change the second texture data having a low frequency of use into the fourth texture data.

The rendering data processing apparatus 124 may obtain texture data that is used to render a tile from the graphics memory 122 or the tile binning unit 123c and may determine a type of the texture data that is stored in consideration of a frequency of use to efficiently provide the texture data.

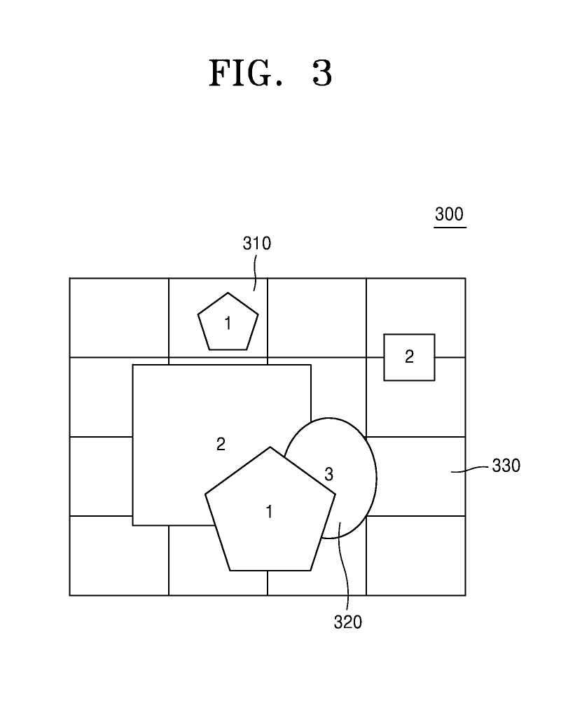

FIG. 3 is a diagram illustrating an example of a method of processing rendering data.

Referring to FIG. 3, a rendering image 300 is divided into 16 tiles (including, for example, a first tile 310, a 2-1 tile 320 and a 2-2 tile 330 that are collectively referred to as the second tiles 320 and 330). The rendering data processing apparatus 124 may obtain texture information of each of the 16 tiles. The rendering data processing apparatus 124 may compare texture information of the selected first tile 310 with texture information of the second tiles 320 and 330 that are rendered after the first tile 310. The second tiles 320 and 330 to be compared may be determined according to a rendering order. For example, when the rendering order is an order of the first tile 310, the 2-1 tile 320, and the 2-2 tile 330, the rendering data processing apparatus 124 may compare the texture information of the first tile 310 with the texture information of the 2-1 tile 320 and the texture information of the 2-2 tile 330. However, varying the rendering order and the number of tiles to be compared according to setting information are considered to be well within the scope of the present disclosure.

The rendering data processing apparatus 124 may confirm, based on the texture information of each of the tiles, that first texture data is used to render the first tile 310; the first texture data, second texture data, and third texture data are used to render the 2-1 tile 320; and the third texture data is used to render the 2-2 tile 330. The rendering data processing apparatus 124 may compare the texture data used to render each tile and may determine a frequency of use of the texture data. From among texture data that is used to render tiles after the first tile, the first and second texture data have a lowest frequency of use of 1, and the third texture data has a highest frequency of use of 2.

The rendering data processing apparatus 124 selects at least one piece of texture data from among the plurality of pieces of texture data of the first tile that are previously stored in a memory according to a frequency of use for rendering of the second tiles 320 and 330. Referring to FIG. 3, the rendering data processing apparatus 124 may select the first texture data having a lowest frequency of use.

The rendering data processing apparatus 124 changes the selected at least one piece of texture data into another piece of texture data. The rendering data processing apparatus 124 may change the first texture data having a low frequency of use in the second tiles 320 and 330 into texture data that is expected to be used for next rendering.

FIG. 4 is a diagram illustrating an example of a method performed by the rendering data processing apparatus 124 to process rendering data based on a type and a size of texture data. The operations in FIG. 4 may be performed in the sequence and manner as shown, although the order of some operations may be changed or some of the operations omitted without departing from the spirit and scope of the illustrative examples described. Many of the operations shown in FIG. 4 may be performed in parallel or concurrently. The above descriptions of FIGS. 1-3, is also applicable to FIG. 4, and is incorporated herein by reference. Thus, the above description may not be repeated here.

In operation S410, the rendering data processing apparatus 124 compares texture information of a selected first tile with texture information of a second tile that is rendered after the first tile, based on texture information of a plurality of pieces of tiles that are included in a rendering image. Information about a type and a size of texture data may be included in the texture information. The rendering data processing apparatus 124 may obtain the texture information of the plurality of tiles that are included in the rendering image from the tile binning unit 123c. The rendering data processing apparatus 124 may also obtain the texture information of the plurality of tiles from the graphics memory 122.

The rendering data processing apparatus 124 may compare a type and a size of texture information that is used to render fragments that are included in the first tile with a type and a size of texture information that is used to render fragments that are included in the second tile.

For example, the rendering data processing apparatus 124 may identify texture data that is used to render the second tile and texture data that is not used to render the second tile, from among texture data that is used to render the first tile by comparing the types of the texture information. Also, the rendering data processing apparatus 124 may compare sizes of the texture data instead of the types of the texture data between the first tile and the second tile. At least one second tile may be compared. For example, the rendering data processing apparatus 124 may select only one second tile, or a plurality of second tiles, for example, 2 or 4 second tiles.

The rendering data processing apparatus 124 may consider a rendering order of the plurality of tiles, to select the second tile. The rendering data processing apparatus 124 may select at least one second tile from among tiles that are adjacent to the selected first tile in the rendering image.

In operation S420, the rendering data processing apparatus 124 selects a plurality of pieces of texture data from among a plurality of pieces of texture data including texture data of the first tile, which are previously stored in a memory according to a frequency of use for rendering of the second tile, based on a result of the comparison.

The rendering data processing apparatus 124 may determine a priority of texture data to be changed from among a plurality of pieces of texture data of the first tile, which are previously stored according to a frequency of use for rendering of the second tile. Texture data having a relatively low frequency of use for rendering of the second tile, from among the pieces of texture data that are previously stored, may have a higher priority than another pieces of texture data.

In operation S430, the rendering data processing apparatus 124 selects at least one piece of texture data from among the selected plurality of pieces of texture data, in consideration of sizes of the selected plurality of pieces of texture data.

For example, the rendering data processing apparatus 124 may compare sizes of pieces of texture data having higher priorities than another pieces of texture data, from among the pieces of texture data that each have the determined priority according to the frequency of use. When first texture data and second texture data having low frequencies of use are selected, the rendering data processing apparatus 124 may compare sizes of the first texture data and the second texture data. When the second texture data is larger than the first texture data, the rendering data processing apparatus 124 may select the second texture data as texture data to be changed in order to more efficiently use a space of the rendering data processing apparatus 124 in which texture data is stored.

Referring back to FIG. 3, when the first texture data has a size of 15 bits, the second texture data has a size of 100 bits, and the third texture data has a size of 250 bits, although a frequency of use of the first texture data is lower than a frequency of use of the third texture data, the third texture data may be selected in consideration of a size of data.

In operation S440, the rendering data processing apparatus 124 changes the selected at least one piece of texture data into another piece of texture data. The rendering data processing apparatus 124 may change texture data having a low frequency of use in the second tile into texture data that is expected to be used for rendering after the first tile. Operation S440 may correspond to operation S230 of FIG. 2. The above descriptions of S230, is also applicable to S440, and is incorporated herein by reference. Thus, the above description may not be repeated here.

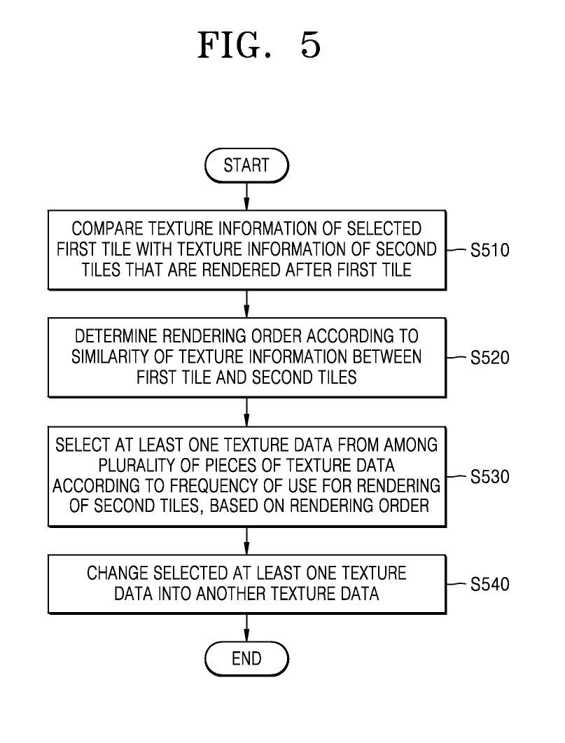

FIG. 5 is a diagram illustrating an example of a method of scheduling a rendering order of tiles based on texture information of the tiles, wherein the method is performed by the rendering data processing apparatus 124. The operations in FIG. 5 may be performed in the sequence and manner as shown, although the order of some operations may be changed or some of the operations omitted without departing from the spirit and scope of the illustrative examples described. Many of the operations shown in FIG. 5 may be performed in parallel or concurrently. The above descriptions of FIGS. 1-4, is also applicable to FIG. 5, and is incorporated herein by reference. Thus, the above description may not be repeated here.

In operation S510, the rendering data processing apparatus 124 compares texture information of a selected first tile with texture information of a plurality of second tiles that are rendered after the first tile, based on texture information of a plurality of tiles included in a rendering image. The rendering data processing apparatus 124 may obtain the texture information of the plurality of tiles that are included in the rendering image from the tile binning unit 123c. The rendering data processing apparatus 124 may also obtain the texture information of the plurality of tiles from the graphics memory 122.

The rendering data processing apparatus 124 may compare a type of texture information that is used to render fragments that are included in the first tile with a type of texture information that is used to render fragments that are included in the second tiles. The rendering data processing apparatus 124 may identify texture data that is used to render the second tiles and texture data that is not used to render the second tiles, from among texture data that is used to render the first tile according to a result of the comparison.

In operation S520, the rendering data processing apparatus 124 determines a rendering order of the plurality of tiles according to a similarity of texture information by comparing texture information between the first tile and the second tiles. The rendering data processing apparatus 124 may identify information about a type of texture data that is used to render each tile. The rendering data processing apparatus 124 may determine the rendering order according to an order in which types of pieces of texture data used to render the tiles are similar.

For example, when 16 tiles are included in the rendering image and rendering is performed beginning from the first tile, the rendering order may be determined so that a third tile that uses in rendering the same texture data as texture data of the first tile the most is rendered after the first tile.

In operation S530, the rendering data processing apparatus 124 selects at least one piece of texture data from among a plurality of pieces of texture data including texture data of the first tile which are previously stored in a memory according to a frequency of use for rendering of the second tiles, based on the rendering order.

Operation S530 may correspond to operation S220 of FIG. 2. The above descriptions of S220, is also applicable to S530, and is incorporated herein by reference. Thus, the above description may not be repeated here.

In operation S540, the rendering data processing apparatus 124 changes the selected at least one piece of texture data into another piece of texture data. The rendering data processing apparatus 124 may change texture data having a low frequency of use in the second tiles into texture data that is expected to be used for rendering after the first tile.

Operation S540 may correspond to operation S230 of FIG. 2. The above descriptions of S230, is also applicable to S540, and is incorporated herein by reference. Thus, the above description may not be repeated here.

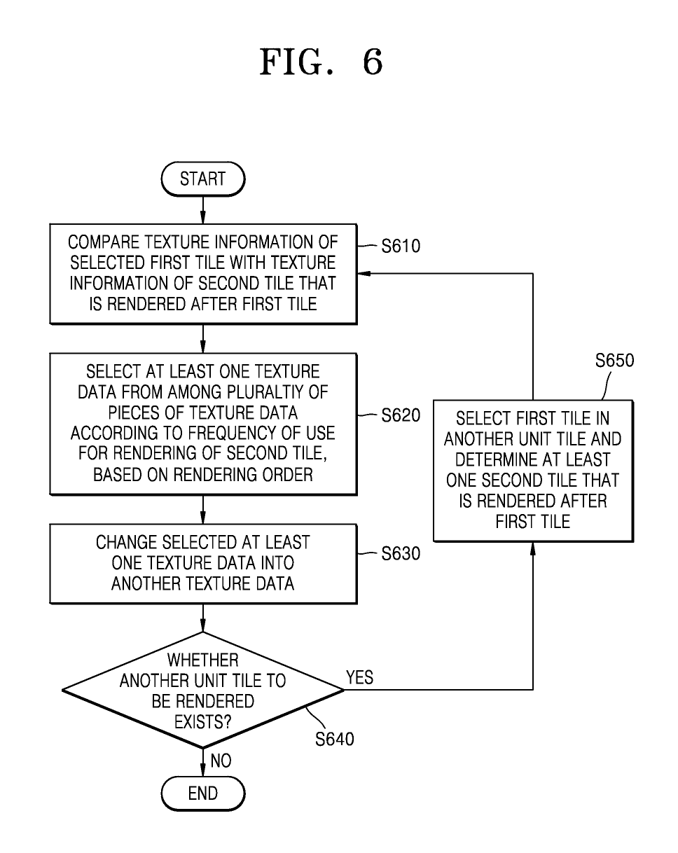

FIG. 6 is a diagram illustrating an example of a method of processing rendering data when image rendering is performed in units of a preset number of tiles. The operations in FIG. 6 may be performed in the sequence and manner as shown, although the order of some operations may be changed or some of the operations omitted without departing from the spirit and scope of the illustrative examples described. Many of the operations shown in FIG. 6 may be performed in parallel or concurrently. The above descriptions of FIGS. 1-5, is also applicable to FIG. 6, and is incorporated herein by reference. Thus, the above description may not be repeated here.

In operation S610, the rendering data processing apparatus 124 compares texture information of a first tile that is selected in unit tiles to be rendered with texture information of a second tile that is rendered after the first tile in the unit tiles, based on texture information of the unit tiles, from among a plurality of tiles that are included in a rendering image. The rendering data processing apparatus 124 may obtain the texture information of the unit tiles to be rendered from the tile binning unit 123c. The rendering data processing apparatus 124 may also obtain the texture information of the unit tiles to be rendered from the graphics memory 122.

The rendering data processing apparatus 124 may compare a type of texture information that is used to render fragments that are included in the first tile with a type of texture information that is used to render fragments that are included in the second tile. The rendering data processing apparatus 124 may identify texture data that is used to render the second tile and texture data that is not used to render the second tile, from among texture data that is used to render the first tile according to a result of the comparison.

In operation S620, the rendering data processing apparatus 124 selects at least one piece of texture data from among a plurality of pieces of texture data including texture data of the first tile which are previously stored in a memory according to a frequency of use for rendering of the at least one second tile, based on a rendering order.

In operation S630, the rendering data processing apparatus 124 changes the selected at least one piece of texture data into another piece of texture data. The rendering data processing apparatus 124 may change texture data having a low frequency of use in the second tile into texture data that is expected to be used for rendering after the first tile.

In operation S640, when rendering is performed on all tiles that are included in the unit tiles to be rendered, the rendering data processing apparatus 124 determines whether another unit tile exists.

In operation S650, the rendering data processing apparatus 124 selects a predetermined tile as the first tile according to a preset rendering order in the other unit tile and determines at least one second tile that is rendered after the first tile. The rendering data processing apparatus 124 may repeatedly perform operations S610 through S640 on tiles that are included in the other unit tile.

The rendering data processing apparatus 124 ends an operation of processing rendering data when no another unit tile to be rendered exists.

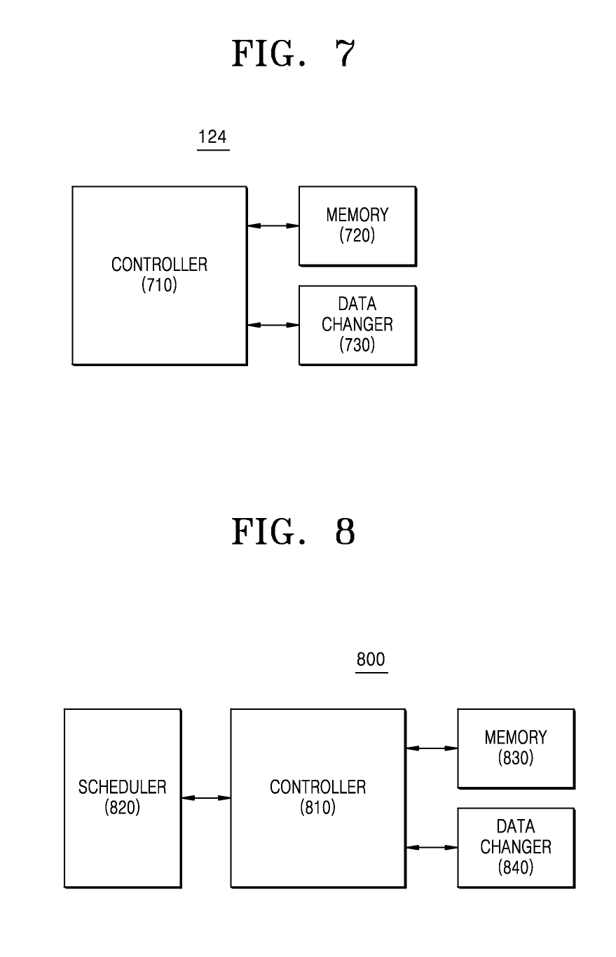

FIG. 7 is a diagram illustrating an example of the rendering data processing apparatus 124.

Referring to FIG. 7, the rendering data processing apparatus 124 may include a controller 710, a memory 720, and a data changer 730. While components related to the present example are illustrated in the rendering data processing apparatus 124 of FIG. 7, it is understood that those skilled in the art may include other general components

The controller 710 compares texture information of a selected first tile with texture information of a second tile that is rendered after the first tile, based on texture information of a plurality of tiles that are included in an image. The controller 710 may obtain the texture information of the plurality of tiles that are included in the image from the tile binning unit 123c. The controller 710 may also obtain the texture information of the plurality of tiles from the graphics memory 122.

The controller 710 may compare a type of texture information that is used to render fragments that are included in the first tile with a type of texture information that is used to render fragments that are included in the second tile. The rendering data processing apparatus 124 may identify texture data that is used to render the second tile and texture data that is not used to render the second tile, from among texture data that is used to render the first tile according to a result of the comparison. The rendering data processing apparatus 124 may compare sizes of the texture data instead of the types of the texture data between the first tile and the second tile.

Also, the controller 710 may compare the texture information of the first tile with texture information of each of the second tiles. The controller 710 may compare texture information of each of a preset number of second tiles with the texture information of the first tile, from among the plurality of second tiles that are included in the rendering image that is not rendered yet.

The controller 710 may consider a rendering order of the plurality of tiles, to select the second tile. The controller 710 may also select at least one second tile, from among tiles that are adjacent to the selected first tile in the rendering image.

The memory 720 stores a plurality of pieces of texture data including texture data that is used to render the first tile. The memory 720 may obtain the plurality of pieces of texture data from the graphics memory 122 or from the tile binning unit 123c.

The data changer 730 selects at least one piece of texture data from among a plurality of pieces of texture data of the first tile that are previously stored in the memory 720 according to a frequency of use for rendering of the second tile, according to a result of the comparison.

The data changer 730 may also determine a priority of texture data to be changed, from among the plurality of pieces of texture data of the first tile that are previously stored according to the frequency of use for rendering of the second tile. Rendering data having a relatively low frequency of use for rendering of the second tile from among the pieces of texture data that are previously stored may have a higher priority than another pieces of texture data. The data changer 730 may determine at least one piece of texture data to be changed according to setting information such as a unit of tiles to be rendered, from among the pieces of texture data that are previously stored and each have the determined priority.

The data changer 730 may also select at least one piece of texture data to be changed based on a size of data, from among pieces of texture data of the first tile having a frequency of use that is lower than a preset value.

The data changer 730 changes the selected at least one piece of texture data into another piece of texture data. The data changer 730 may change texture data having a low frequency of use in the second tile into texture data that is expected to be used for rendering after the first tile.

FIG. 8 is a diagram illustrating an example of a rendering data processing apparatus 800. The rendering data processing apparatus 800 may perform operations corresponding to operations of the rendering data processing apparatus 124 of FIG. 1.

Referring to FIG. 8, the rendering data processing apparatus 800 may include a controller 810, a memory 830, a data changer 840, and a scheduler 820. While components related to the present example are illustrated in the rendering data processing apparatus 800 of FIG. 8, it is understood that those skilled in the art may include other general components

The controller 810 compares texture information of a selected first tile with texture information of a second tile that is rendered after the first tile, based on texture information of a plurality of tiles that are included in an image. The controller 810 may correspond to the controller 710 of FIG. 7. The above descriptions of controller 710 of FIG. 7, is also applicable to controller 810, and is incorporated herein by reference. Thus, the above description may not be repeated here.

The scheduler 820 determines a rendering order of the plurality of tiles according to a similarity of texture information between the plurality of tiles, by comparing texture information between the plurality of tiles. The rendering data processing apparatus 800 may determine information about a type of texture data that is used to render each tile. The rendering data processing apparatus 800 may determine the rendering order according to an order in which types of pieces of texture data used to render the tiles are similar.

The memory 830 stores a plurality of pieces of texture data that are used to render the first tile. The memory 830 may correspond to the memory 720 of FIG. 7. The above descriptions of memory 720 of FIG. 7, is also applicable to memory 830, and is incorporated herein by reference. Thus, the above description may not be repeated here.

The data changer 840 selects at least one piece of texture data from among the plurality of pieces of texture data of the first tile that are previously stored in the memory 830 according to a frequency of use for rendering of the second tile, based on a result of the comparison and the determined rendering order, and changes the selected at least one piece of texture data into another piece of texture data. The data changer 840 may correspond to the data changer 730 of FIG. 7. The above descriptions of data changer 730 of FIG. 7, is also applicable to controller 840, and is incorporated herein by reference. Thus, the above description may not be repeated here.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

The processes, functions, and methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, Wi-Fi, etc.). In addition, functional programs, codes, and code segments for accomplishing the example disclosed herein can be construed by programmers skilled in the art based on the flow diagrams and block diagrams of the figures and their corresponding descriptions as provided herein.

The particular implementations shown and described herein are illustrative examples and are not intended to otherwise limit the scope of the present disclosure. For the sake of brevity, conventional electronics, control systems, software development and other functional aspects of the systems may not be described in detail. Furthermore, the connecting lines, or connectors shown in the various figures presented are intended to represent functional relationships and/or physical or logical couplings between the various elements. It should be noted that many alternative or additional functional relationships, physical connections or logical connections may be present in a practical device.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of processing rendering data, the method comprising:
comparing texture information of a first tile with texture information of a second tile that is rendered after the first tile;
selecting at least one piece of texture data from pieces of texture data of the first tile according to a frequency of use of the at least one piece of texture data for rendering the second tile; and
changing the selected at least one piece of texture data into another piece of texture data.

2. The method of claim 1, wherein the selecting of the at least one piece of texture data comprises determining a priority of texture data to be changed based on the texture data to be changed having a lesser frequency of use.

3. The method of claim 1, wherein the comparing of the texture information comprises comparing the texture information of the first tile with texture information of each of a plurality of the tiles rendered after the first tile.

4. The method of claim 1, further comprising obtaining information about a rendering order of tiles included in a rendering image,
wherein the comparing of the texture information comprises selecting at least one tile that is rendered after the first tile based on the rendering order.

5. The method of claim 1, wherein the selecting of the at least one piece of texture data comprises selecting the at least one piece of texture data based on a size of data, from pieces of texture data of the first tile having a frequency of use lower than a value.

6. The method of claim 1, wherein the comparing of the texture information comprises obtaining information about some tiles included in a rendering image and comparing the information,
wherein in response to the at least one piece of texture data being selected and changed from among the some tiles, the method further comprises obtaining and comparing information about others tiles included in the rendering image.

7. The method of claim 1, further comprising comparing texture information between a plurality of tiles included in a rendering image and determining a rendering order of the plurality of tiles according to a similarity of the texture information between the plurality of tiles.

8. The method of claim 1, wherein the comparing of the texture information comprises comparing the texture information of the first tile that is selected with the texture information of the second tile that is rendered after the first tile, based on texture information of tiles adjacent to the first tile.

9. A computer-readable recording medium having embodied thereon a program for executing the method of claim 1.

10. An apparatus for processing rendering data, the apparatus comprising:
a controller configured to compare texture information of a first tile with texture information of a second tile that is rendered after the first tile;
a memory to stores pieces of texture data used to render the first tile; and
a data changer configured to select at least one piece of texture data from pieces of texture data that are stored in the memory according to a frequency of use of the least one piece of texture data for rendering of the second tile, and to change the selected at least one piece of texture data into another piece of texture data.

11. The apparatus of claim 10, wherein the controller is further configured to determine a priority of texture data to be changed based on the texture data to be changed having a lesser frequency of use.

12. The apparatus of claim 10, wherein the controller is further configured to compare the texture information of the first tile with texture information of each of a plurality of the tiles rendered after the first tile.

13. The apparatus of claim 10, wherein the controller is further configured to obtain information about a rendering order of tiles included in a rendering image, and to select at least one tile that is rendered after the first tile based on the rendering order.

14. The apparatus of claim 10, wherein the data changer is further configured to select the at least one piece of texture data based on a size of data from pieces of texture data of the first tile having a frequency of use lower than a value.

15. The apparatus of claim 10, wherein the controller is further configured to obtain and compare information about some of tiles that are included in a rendering image,
wherein in response to the at least one piece of texture data being selected and changed from among the some tiles, the controller obtains and compares information about others tiles included in the rendering image.

16. The apparatus of claim 10, further comprising a scheduler configured to compare texture information between a plurality included in a rendering image of tiles and to determine a rendering order of the plurality of tiles according to a similarity of the texture information between the plurality of tiles.

17. The apparatus of claim 10, wherein the controller is further configured to compare the texture information of the first tile that is selected with the texture information of the second tile that is rendered after the first tile, based on texture information of tiles that are adjacent to the first tile.

18. A method of processing rendering data, the method comprising:
comparing texture information of a first tile with texture information of a second tile that is rendered after the first tile;
selecting at least one piece of texture data from pieces of texture data of the first tile based on a size of the pieces of texture data of the first tile and the at least one piece of texture data having a frequency of use lower than a threshold when rendering the second tile; and
changing the selected at least one piece of texture data into another piece of texture data.
